(19) United States
(12) Patent Application Publication
(10) Pub. No.: US 2006/0225012 A1
(43) Pub. Date: Oct. 5, 2006

(54) Layout verification method and layout design unit

(75) Inventor: Manabu Deura, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/166,153

(22) Filed: Jun. 27, 2005

(30) Foreign Application Priority Data
Mar. 31, 2005 (JP) 2005-102718

(51) Int. Cl. G06F 17/50

(52) U.S. Cl. 716/5

(57) ABSTRACT

By providing plural layers in which circuit components of an integrated circuit using plural voltages are arranged in accordance with used voltages, separately arranging the circuit component to which a high voltage is applied in a specific layer among the plural layers, recognizing the used voltage for each layer, and performing a layout verification by applying a condition in accordance with the used voltage, it is possible to recognize the circuit component, to which a high voltage is applied, on the layout, and to perform the layout verification using a layout rule in accordance with the used voltage using only the layers used in an actual process without newly generating a dummy layer etc.

### CROSS-REFERENCE TO RELATED APPLICATIONS

This application is based upon and claims the benefit of priority from the prior Japanese Patent Application No. 2005-102718, filed on Mar. 31, 2005, the entire contents of which are incorporated herein by reference.

### BACKGROUND OF THE INVENTION

1. Field of the Invention

The present invention relates to a layout verification method and a layout design unit for an integrated circuit in which elements and wires using different voltages exist concurrently.

2. Description of the Related Art

In designing a large-scale integrated (LSI) circuit etc., it is necessary to change a layout rule on an LSI design in accordance with a voltage to be applied (used voltage). For example, the layout rule specifies a clearance between metal wires, a clearance between a wire including polysilicon used as a wire and an element region as shown in FIG. 8, etc., which are provided in order to prevent the dielectric breakdown of an interlayer insulating film by an electric field.

FIG. 8 is a diagram for explaining the concept of an equivalent node in the layout rule. In FIG. 8, a reference number 81 denotes an element region in which a circuit element is formed, 82 denotes a metal wire, and 83 denotes polysilicon used as a wire. As shown in FIG. 8, the metal wire 82 and the polysilicon 83 are electrically connected by a contact 84. In such a configuration, a clearance L8 is secured between the element region 81 and the polysilicon 83 on the assumption that if the metal wire 82 is a wire to which a high voltage is applied, a high voltage is also applied to the polysilicon 83 electrically connected thereto.

Conventionally, however, even though some voltages, more or less, were applied to a wire etc. on the layout, it was impossible to perform a layout rule verification in accordance with the used voltage, that is, a so-called design rule check (DRC) because there was no method for recognizing the voltage, which is applied, from the layout.

As a technique for performing the layout rule verification, there is a method in which: the voltage of an element is recognized from withstand voltage information added to a pad, or data of a LVS (layout versus schematic check) for verifying whether or not the connection is realized correctly; and the element judged to be a high-voltage element is caused to generate a dummy layer, which is not used in an actual process, for distinction even though it is of identical type (for example, refer to Patent Document 1).

There is another method in which information for connection (node attribute) is added to a node using a text (for example, refer to Patent Document 2) or there is still another method in which: a net list is configured so that a single wiring pattern layer is divided into plural sub wiring pattern layers with different design rule check levels; and the sub wiring pattern layers are formed into a wiring pattern layer by superposition using perspective projections (for example, refer to Patent document 3).

[Patent Document 1] Japanese Patent Application Laid-Open No. 2000-124320

[Patent Document 2] Japanese Patent Application Laid-Open No. Hei 4-304562

[Patent Document 3] Japanese Patent Application Laid-Open No. Hei 2-93984

### SUMMARY OF THE INVENTION

An object of the present invention is to make it possible to perform a layout rule verification of the clearance between wires, the clearance between a wire and an element, etc. in accordance with the used voltage using only layers used in an actual process.

The layout verification method of the present invention is characterized in that the layout verification is performed by providing plural layers in which circuit components of an integrated circuit using plural voltages are arranged in accordance with used voltages, separately arranging the circuit component to which a high voltage is applied in a specific layer among the plural layers, recognizing the used voltage for each layer, and applying a condition in accordance with the used voltage.

According to the present invention, the circuit component to which a high voltage is applied is separately arranged in a specific layer, thereby making it possible to recognize the circuit component, to which a high voltage is applied, on the layout, and to perform the layout verification.

Further, the layout verification method of the present invention is characterized in that the layout verification is performed by providing plural layers in which circuit components of an integrated circuit using plural voltages are arranged, recognizing a circuit element, to which a high voltage may be applied in the integrated circuit, from the layer or a combination of layers, and at the same time recognizing the circuit component connected to the recognized circuit element as one to which a high voltage is applied.

According to the present invention, the circuit element to which a high voltage may be applied is recognized from the layer or a combination of the layers, and the circuit component connected hereto is recognized as a circuit component to which a high voltage is applied, thereby making it possible to recognize the circuit component, to which a high voltage is applied, on the layout, and to perform the layout verification.

### BRIEF DESCRIPTION OF THE DRAWINGS

FIG. 1 is a diagram showing a configuration example of a layout verifier in a first embodiment;

FIG. 2A and FIG. 2B are diagrams for explaining the layout principles in the first embodiment;

FIG. 3 is a flow chart showing a layout rule verification operation in the first embodiment;

FIG. 4A and FIG. 4B are diagrams for explaining the used voltage determination principles in a second embodiment;

FIG. 5 is a flow chart showing a layout rule verification operation in the second embodiment;

FIG. 6 is a diagram for explaining the used voltage determination principles in another example in the second embodiment;

FIG. 7 is a flow chart showing a layout rule verification operation in the second embodiment; and

FIG. 8 is a diagram showing the concept of an equivalent node in the layout rule.

### DETAILED DESCRIPTION OF THE PREFERRED EMBODIMENTS

Embodiments of the present invention are explained below based on the drawings.

### First Embodiment

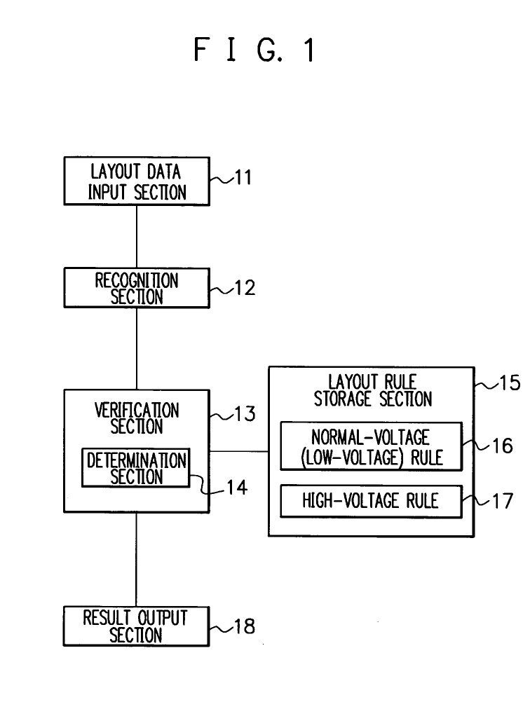

FIG. 1 is a block diagram showing a configuration example of a layout verifier according to a first embodiment of the present invention. As shown in FIG. 1, the layout verifier in the first embodiment has a layout data input section 11, a recognition section 12, a verification section 13, a layout rule storage section 15, and a result output section 18.

The layout data input section 11 inputs layout data of an integrated circuit.

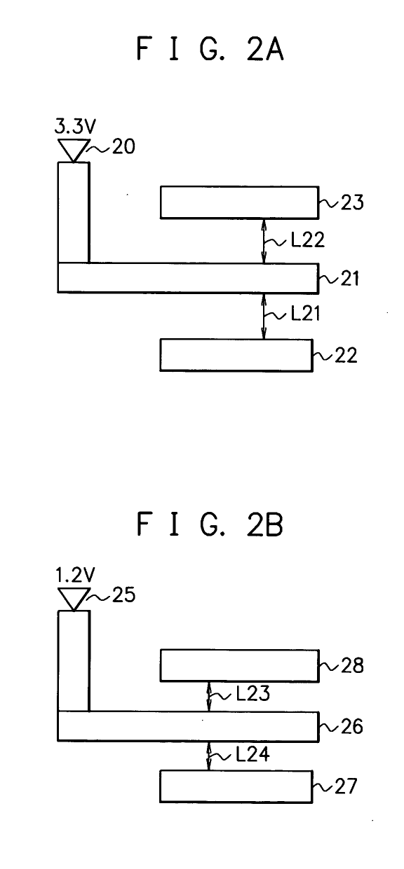

In the integrated circuit of this embodiment, plural voltages having different voltage values are used in its interior, and as shown in FIG. 2, which will be described later, plural layers in which circuit components of the integrated circuit are laid out for arrangement are provided. In this embodiment, the plural layers are provided in accordance with the used voltages, and components such as a metal wire, polysilicon used as a wire and a via to which a high voltage is applied are arranged in a specific layer. Hereinafter, for simplicity of explanation, the specific layer is referred to as a “high-voltage layer”. In other words, in this embodiment, circuit components used at a high voltage and circuit components used at a normal voltage (a low voltage) are arranged separately in the high-voltage layer and in the normal voltage layer, respectively.

The recognition section 12 recognizes a used voltage based on the layout data input from the layout data input section 11. In the first embodiment, since the used voltage is defined for each layer, the recognition section 12 recognizes the used voltage for each layer, that is, the recognition section 12 recognizes whether the layer is the high-voltage layer or the normal-voltage layer.

The verification section 13 verifies whether or not the layout of the integrated circuit relating to the layout data input from the layout data input section 11 satisfies the layout rule (design rule), that is, performs a so-called design rule check. The layout rule (design rule) used for the verification is stored in the layout rule storage section 15, and in this embodiment, a normal-voltage (low-voltage) rule 16 and a high-voltage rule 17 are stored.

Specifically, the verification section 13 reads out either the normal-voltage (low-voltage) rule 16 or the high-voltage rule 17 from the layout rule storage section 15 based on the recognition result by the recognition section 12 for each layer. Then, a determination section 14 in the verification section 13 determines whether or not the clearance between wires etc. in the layout of the integrated circuit relating to the input layout data satisfies a predetermined condition. Due to this, the voltage used in the layer can be recognized based on the input layout data and the layout verification of the integrated circuit can be performed by applying the layout rule in accordance with the used voltage.

The result output section 18 outputs a layout verification result by the verification section 13 and outputs error information when, for example, a violation (error) of the layout rule is detected in the layout verification.

FIG. 2A and FIG. 2B are diagrams for explaining the principles of the integrated circuit layout in the first embodiment. As shown in FIG. 2A, one example is explained, in which 3.3 V-wires 21 and 22 to which a voltage of 3.3 V supplied from a power supply 20 for outputting 3.3 V is applied and a 1.2 V-wire 23 to which a voltage of 1.2 V different from it is applied exist concurrently. In FIG. 2B, one example is shown, in which 1.2 V-wires 26, 27, and 28 to which a voltage of 1.2 V supplied from a power supply 25 for outputting 1.2V is applied are arranged in the same arrangement as that in FIG. 2A.

It is necessary for the wires 21 and 22 to which a high voltage (3.3 v) is applied to have clearances L21 and L22 with neighboring circuit components (a wire, an element region, etc.) greater than minimum machining dimensions L23 and L24 set in order to avoid the occurrence of a trouble such as dielectric breakdown of an interlayer insulating film. Here, the minimum machining dimensions L23 and L24 are minimum values of the clearance between circuit components to which a normal voltage (1.2 V) lower than 3.3 V is applied respectively, and it is possible to avoid the occurrence of the trouble such as dielectric breakdown of an interlayer insulating film at the parts of a 1.2 V-system if a clearance greater than the minimum machining dimension is provided.

As shown in FIG. 2A, in the case where the 3.3 V-wires 21 and 22 and the 1.2 V-wire 23 exist concurrently, the 3.3 V-wires 21 and 22 are arranged in the high-voltage layer and the 1.2 V-wire 23 is arranged in the normal-voltage layer in this embodiment. By putting together the high-voltage layer and the normal-voltage layer (superposing as in the case of perspectives), the layout of a single wiring layer in which the 3.3 V-wires 21 and 22 and the 1.2 V-wire 23 exist concurrently is formed as shown in FIG. 2A.

Here, the high-voltage layer is provided as a layer, for which a rule check for a high voltage is performed, in a level code table (layer list) used when performing a layout. A layout designer designs a layout by selectively using a layer for which a normal check is performed (normal-voltage layer), and a layer for which a high-voltage check is performed (high-voltage layer) and arranging circuit components with a use condition of wires etc. born in mind.

Next, the layout verification operation in the first embodiment is explained.

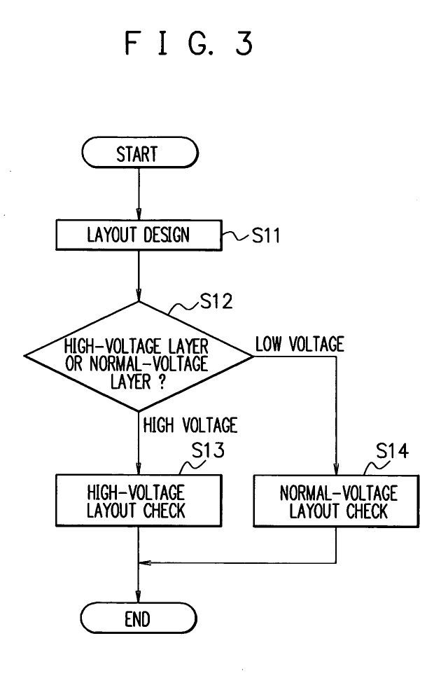

FIG. 3 is a flow chart showing the layout rule verification operation in the first embodiment.

First, as shown above, a layout of the integrated circuit is designed by laying out the circuit components to which a high voltage is applied (used at a high voltage) in the high-voltage layer and the circuit components to which a normal voltage is applied (used at a normal voltage) in the normal-voltage layer (step S11).

When the layout data having plural layers obtained by the layout design in step S11 is input from the layout data input section 11, the recognition section 12 recognizes whether it is for the high-voltage layer or the low-voltage layer for each layer. In other words, the recognition section 12 recognizes whether the voltage to be used is a high voltage or a normal voltage for each layer (step S12).

When the result is that the layer is the high-voltage layer, the verification section 13 reads out the high-voltage rule 17 from the layout rule storage section 15 and performs the layout verification for a high voltage according to the rule (step S13). On the other hand, in the case of the normal-voltage layer, the verification section 13 reads out the normal-voltage rule 16 from the layout rule storage section 15 and performs the layout verification for a normal voltage according to the rule (step S14).

Then, the result of the layout verification is output from the result output section 18 and the operation is completed.

As described above, according to the first embodiment, in the layout design of the integrated circuit, the plural layers are used, thereby to arrange the circuit components to which a high voltage is applied in the high-voltage layer different from the normal-voltage layer in which the circuit components to which a normal voltage is applied are arranged. By separately arranging the circuit component to which a high voltage is applied in a specific layer, as described above, it is possible to recognize the circuit component used at a high voltage from the layout using only the layers used in an actual process without newly generating a dummy layer etc., and to perform the layout verification based on the layout rule in accordance with the voltage.

Circuit components are not limited to those described above, and may include, for example, a metal wire, polysilicon used as a wire, a via, a well, an element, etc. Further, the plural layers are classified into the high-voltage layer and the normal-voltage layer, but the classification is not limited to this, and the layer may be provided, for example, for each voltage to be used.

### Second Embodiment

Next, a second embodiment of the present invention is explained.

In the second embodiment to be explained below, the circuit elements such as, for example, a specific element, a well having a high voltage applied, and a power supply, which have the possibility of being used at a high voltage, i.e. to which a high voltage may be applied, are recognized from the layer or the combination of layers. Then, the wire including polysilicon which is an equivalent node hereto and a resistive element is recognized as one to which a high voltage is applied, that is, the circuit component electrically connected to the circuit element to which a high voltage may be applied is recognized as one to which a high voltage is applied.

The integrated circuit in this embodiment is also an integrated circuit in which plural voltages of which the value is different in its interior are used, and plural layers are provided, in which the circuit components of the integrated circuit are laid out for arrangement.

Since the general configuration of the layout verifier in the second embodiment is similar to that in the first embodiment shown in FIG. 1, no explanation will be given here. However, in the second embodiment, the recognition section 12 does not recognize the used voltage from the layer itself, but recognizes the circuit element, to which a high voltage is applied, from the layer or the combination of layers, and further recognizes the circuit component connected to the circuit element as one to which a high voltage is applied.

The verification section 13 verifies whether or not the layout of each circuit element, wire, etc. constituting the integrated circuit satisfies the layout rule based on the recognition result by the recognition section 12.

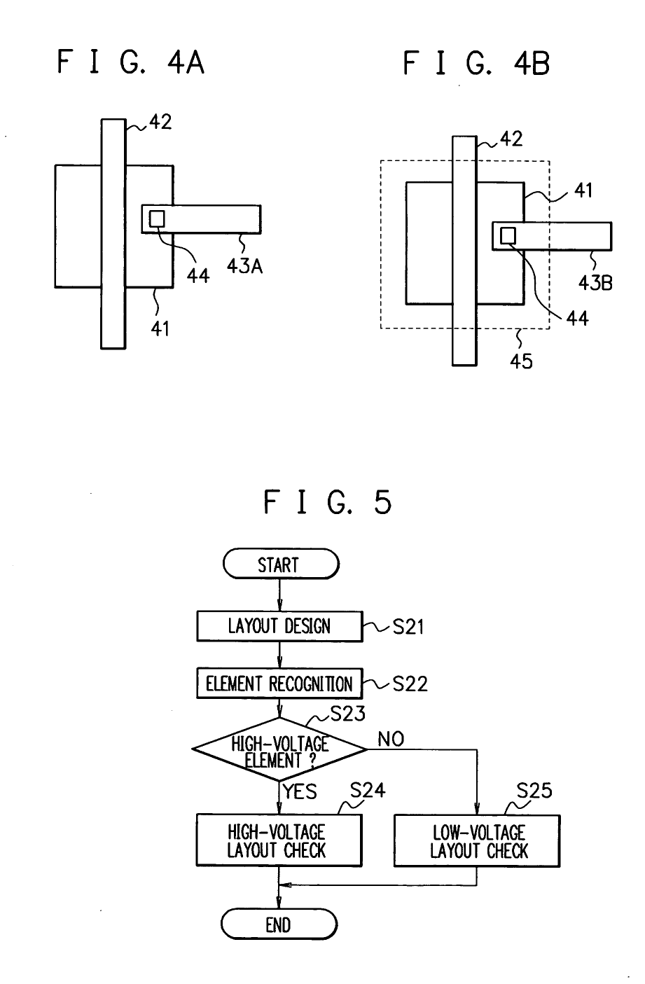

FIG. 4A and FIG. 4B are diagrams for explaining the determination principles of the used voltage in the second embodiment.

Both of FIG. 4A and FIG. 4B are diagrams schematically showing a transistor and a wire connected thereto, and the transistor shown in FIG. 4B is one that may be used at a high voltage. In FIG. 4A and FIG. 4B, a reference number 41 denotes an element region relating to the transistor, 42 denotes polysilicon used as a wire, and 43A and 43B denote metal wires. The element region 41 and the metal wire 43 are electrically connected via a contact 44.

Here, as shown in FIG. 4B, for example, the transistor covered with a layer 45 called an FH, which is used to increase the thickness of the gate oxide film of the transistor, may be used at a high voltage. Therefore, as shown in FIG. 4B, the transistor covered with the layer 45 called an FH is recognized as a circuit element to which a high voltage is applied, and the metal wire 43B electrically connected thereto is recognized as a wire to which a voltage of 3.3 V is applied.

On the other hand, as shown in FIG. 4A, the transistor that does not have the layer 45 called an FH is recognized as a circuit element to which a high voltage is not applied, that is, which operates at a normal voltage, and the metal wire 43A is recognized as a wire to which a voltage of 1.2 V is applied.

In the second embodiment, as described above, the circuit element having a pattern specific to a high voltage is recognized from the layer or the combination of layers, and the circuit component connected thereto is recognized as one to which a high voltage is applied.

Next, the layout verification operation in the second embodiment is explained below.

FIG. 5 is a flow chart showing the layout rule verification operation in the second embodiment.

First, the layout of the integrated circuit is designed by laying out the circuit components in each layer using plural layers (step S21).

Next, when the layout data obtained by the layout design in step S21 is input from the layout data input section 11, the recognition section 12 recognizes a circuit element from the layer or the combination of layers (step S22). Further, the recognition section 12 judges whether or not the recognized circuit element is one to which a high voltage is applied (step S23).

When the result is that the circuit element is one to which a high voltage is applied, the circuit component connected thereto is also recognized as one to which a high voltage is applied. Then, the verification section 13 reads out the high-voltage rule 17 from the layout rule storage section 15 and performs the layout verification for a high voltage in accordance with the rule (step S24).

On the other hand, when the judgment result is that the circuit element is not one to which a high voltage is applied, that is, one to which a normal voltage is applied, the circuit component connected thereto is also recognized as one to which a normal voltage is applied. The verification section 13 reads out the normal-voltage rule 16 from the layout rule storage section 15 and performs the layout verification for a normal voltage in accordance with the rule (step S25).

When the layout verification of the entire integrated circuit is completed in the manner described above, the result of the layout verification is output from the result output section 18 and the operation is completed.

As describe above, according to the second embodiment, by recognizing the specific pattern (layer) possessed by the circuit element to which a high voltage is applied, the circuit element to which a high voltage is applied and the circuit element to which a high voltage is not applied are distinguished from each other. Further, as for the circuit element recognized as one to which a high voltage is applied, the circuit component connected thereto is also recognized as one to which a high voltage is applied. By recognizing the circuit element, to which a high voltage is applied, from the layer or the combination of layers and regarding the circuit component connected thereto as one to which a high voltage is applied, as described above, it is possible to recognize the circuit component used at a high voltage using only the layers used in an actual process without newly generating a dummy layer etc. and to perform the layout verification based on the layout rule in accordance with the voltage.

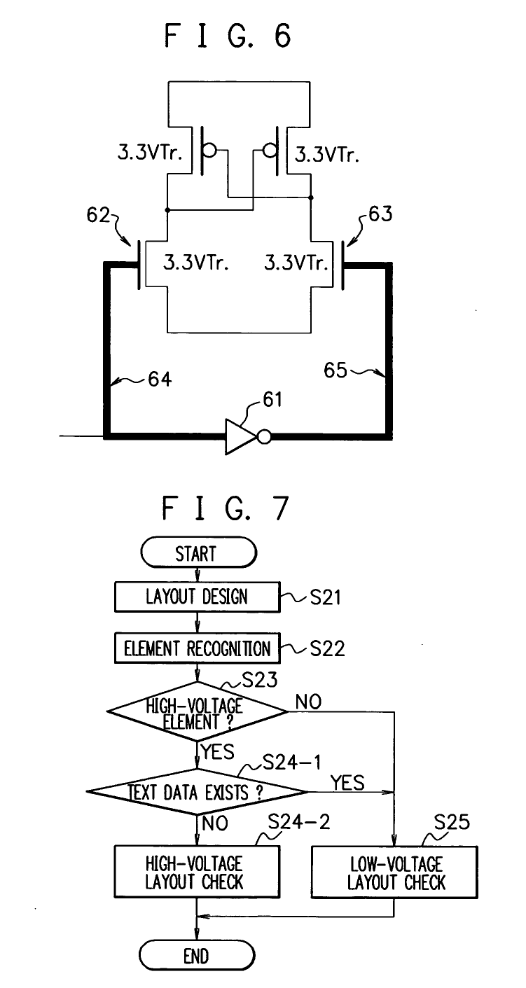

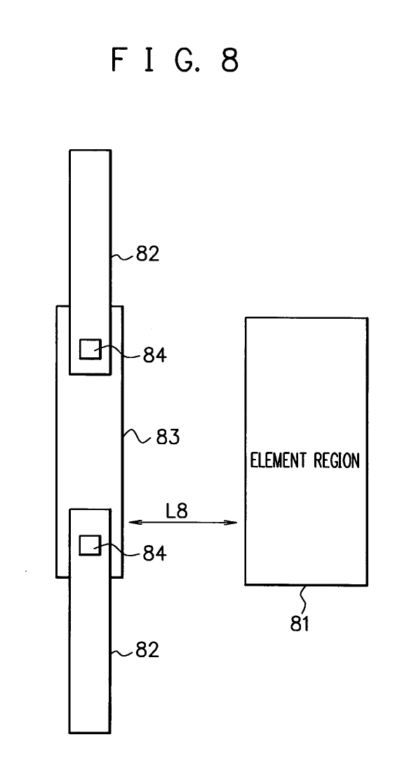

In the second embodiment described above, the layout verification is performed on the assumption that the high voltage is applied unconditionally to all the circuit components connected to the circuit element regarded as one to which a high voltage is applied. However, when a transistor used at a normal voltage (a low voltage) and a transistor connected to the circuit component operating at a high voltage are connected with a wire, as is the case with a level converting circuit shown in FIG. 6, only a voltage of 1.2 V at most is applied to wires 64 and 65 for making a connection of the input terminal and output terminal of an inverter 61 that operates at 1.2 V and gates of transistors 62 and 63, so there is the possibility that a pseudo error occurs if a layout is designed in accordance with the 1.2 V rule.

Methods for avoiding this may include one in which information about a voltage to be applied (for example, information indicating that only a normal voltage is applied) is given to the circuit component such as wire, which is connected to the circuit element to which a high voltage is applied, but to which only a normal voltage is applied. Then, in the recognition section 12, the information may be recognized, thereby to perform the layout verification based on the layout rule in accordance with the voltage to be applied. The information about the voltage to be applied given to the circuit component is arbitrary, and a mark such as symbol, which is defined in advance, may be used or text data may be used to show the information more explicitly. Due to this, it is also possible to avoid the occurrence of an unwanted error in the layout verification.

FIG. 7 is a flow chart showing the layout rule verification operation when information about a voltage to be applied is given to the circuit component as described above. FIG. 7 shows a case where information indicating that a normal voltage is applied to the circuit component, which has been connected to the circuit element to which a high voltage is applied, is given in the format of text data.

The processes in steps S21 to S23, S24-2, and S25 in FIG. 7 correspond to that of steps S21 to S23, S24, and S25 shown in FIG. 5 described above, respectively, and the operation of the former is the same as that of the latter, so no explanation will be given here, and only the process in step 24-1 different from that in FIG. 5 is explained below.

The operation in step S24-1 is as follows.

When the judgment result in step S23 is that the circuit element is one to which a high voltage is applied, the circuit component connected thereto is also regarded as one to which a high voltage is applied. However, the recognition section 12 judges whether or not information indicating that a normal voltage is applied to the circuit component (text data) has been given thereto. When the judgment result is that the information indicating that a normal voltage is applied has been given to the circuit component, the operation proceeds to step 25, in which the layout verification for a normal voltage is performed, and otherwise, the operation proceeds to step 24-2, in which the layout verification for a high voltage is performed.

The embodiments described above are only for showing examples of embodiments for embodying the present invention and it should not be interpreted that these embodiments limit the technical scope of the present invention. In other words, various modifications of the present invention may be carried out without departing from the technical concept and the main features of the present invention.

According to the present invention, in performing the layout verification, even though only the layers used in an actual process is used without newly generating a dummy layer etc., it is possible to recognize the circuit component, to which a high voltage is applied, on the layout, and to perform the layout verification based on the layout rule in accordance with the used voltage.

What is claimed is:

1. A layout verification method of an integrated circuit using plural voltages having different voltage values, wherein a layout verification is performed by providing plural layers in which circuit components of said integrated circuit are arranged in accordance with used voltages, separately arranging said circuit component to which a high voltage is applied in a specific layer among said plural layers, recognizing the used voltage for each said layer, and applying a condition in accordance with the used voltage.

2. The layout verification method according to claim 1, wherein said layers include a high-voltage layer corresponding to said specific layer and a normal-voltage layer in which said circuit component to which a normal voltage is applied is arranged.

3. The layout verification method according to claim 1, wherein said layer is provided for each said used voltage.

4. The layout verification method according to claim 1, wherein said plural layers in accordance with the used voltages form a single-layer layout of said integrated circuit by being put together.

5. The layout verification method according to claim 1, wherein a code table in which the used voltages of said layers are registered is provided.

6. The layout verification method according to claim 1, wherein said circuit components include at least one of a metal wire, polysilicon to be used as a wire, a via, a well, and an element.

7. A layout verification method of an integrated circuit using plural voltages having different voltage values, wherein a layout verification is performed by providing plural layers in which circuit components of said integrated circuit are arranged, recognizing a circuit element, to which a high voltage may be applied in said integrated circuit, from said layer or a combination of said layers, and at the same time recognizing a circuit component connected to said recognized circuit element as one to which a high voltage is applied.

8. The layout verification method according to claim 7, wherein a wire including polysilicon or a resistive element connected to a circuit element recognized as one to which a high voltage is applied is recognized as a wire to which a high voltage is applied.

9. The layout verification method according to claim 7, wherein a layout verification is performed by adding information indicating a used voltage to said circuit component and applying a condition in accordance with the used voltage based on said information.

10. The layout verification method according to claim 9, wherein said information indicating the used voltage is information indicating that a high voltage is not applied, and wherein
the layout verification is performed by excluding the circuit component to which said information has been added from those to which a high voltage is applied.

11. The layout verification method according to claim 9, wherein said information indicating the used voltage is text data.

12. A layout design unit for designing a layout of an integrated circuit using plural voltages having different voltage values, wherein plural layers in which circuit components of said integrated circuit are arranged are provided in accordance with used voltages, and
wherein said circuit component to which a high voltage is applied is separately arranged in a specific layer among said plural layers.
